(19) United States
(12) Patent Application Publication
(10) Pub. No.: US 2013/0052094 A1
(43) Pub. Date: Feb. 28, 2013

(54) DEVICE FOR TREATING EXHAUST GASES FROM A SMALL HEATING SYSTEM

(71) Applicant: Martin Pley, Memmelsdorf (DE)

(72) Inventor: Martin Pley, Memmelsdorf (DE)

(21) Appl. No.: 13/578,208

(22) PCT Filed: Feb. 9, 2011
(86) PCT No.: PCT/EP11/00613

§ 371 Date: Nov. 5, 2012

Related U.S. Application Data
(60) Provisional application No. 61/372,199, filed on Aug. 10, 2010.

(30) Foreign Application Priority Data
Feb. 9, 2010 (DE) 10 2010 007 253.2
May 26, 2010 (AT) GM 342/2010
May 26, 2010 (DE) 20 2010 007 246.8
Aug. 10, 2010 (EP) 10008340.1

(51) Int. Cl. F01N 3/28; B05D 5/00; B08B 7/00; F24B 1/00

(52) U.S. Cl. 422/170; 422/168; 422/173; 422/181; 427/180; 134/6

(57) ABSTRACT

A device for treating exhaust gases from a heating system, preferably a small heating system, particularly a small heating system used in private households, comprising: a catalytic device comprising a catalytically active material, wherein the catalytically active material is a ceramic by means of which an oxidation of exhaust compounds is catalyzable; and wherein the catalytic device comprises a plurality of apertures through which the exhaust gases may flow; characterized in that the catalytic device comprises a bulk material comprising a plurality of bulky components.

### FIELD OF THE INVENTION

The invention relates to a device comprising a catalytic device for treating exhaust gases from a heating system, particularly exhaust gases from a small heating system in a private household, to an apparatus comprising said device, to a heating system comprising said device or apparatus, to a process for the manufacture and/or regeneration of such device, and to the use of the device and apparatus for treating the exhaust gases from a heating system.

### BACKGROUND OF THE INVENTION

Small heating systems, also termed as small combustion systems, which are operated with solid fuel such as wood, wood pellets, or carbon such as coal or brown coal, may often be found in private households, where they complete or replace traditional heating systems. In the Federal Republic of Germany, the allowed emissions of these small heating systems are regulated, due to the low thermal output of said systems, by the First Federal Immission Protection Ordinance (1. BlmSchV), which was modified by a decision of the German Bundestag in Dec. 3, 2009. In this 1. BlmSchV, small and medium heating systems are regulated. Heating systems and heating systems for single rooms such as wood-burning stoves, tile stoves, cookers and opened fire places have to be mentioned among other systems. Said systems need not be approved by governmental regulations. Alone in Germany, about 15 millions of small heating systems are in use, with increasing tendency. Typical emissions of modern wood-burning stoves or wood burning fire place inserts are approx. 60 mg/Nm³ for particulate matter, and approx. 1500 mg/Nm³ for carbon monoxide. Short-chained organic compounds are also emitted, which mainly contribute to odor formation.

Even if small heating systems are properly operated, in particular particulate matter, short-chained organic compounds, polycyclic aromatic hydrogen carbons (PAKs), and carbon monoxide are emitted. If improperly operated, e.g. combusting halogenated organic compounds such as PVC etc., highly toxic poly halogenated dibenzodioxins or dibenzofurans may be released.

The filtering or purification of exhaust gases from small heating systems by means of adequate devices is generally known. When developing small heating systems, the experts take particular care of process parameters, e.g. in order to adapt the combustion chamber and the air flow to an emission-free combustion by means of primary measures. It is also known to limit emissions by means of catalysts. Mostly, such catalysts are based on transition metals which, however, may be lastly deactivated due to the presence of catalyst poisons in the fuel such as arsenic, sulfur or phosphorus compounds. Said catalyst poisons may be found in traces (phosphorus and arsenic) or up to an amount of 1% (sulfur), particularly in wood or in other solid fuels, which are preferably used in small heating systems.

### OBJECT OF THE INVENTION

One object of the present invention is to further reduce emissions from heating systems, preferably from small heating systems.

### SUMMARY OF THE INVENTION

According to a first aspect, the invention relates to a device for treating exhaust gases from a heating system, preferably a small heating system, particularly a small heating system used in private households, comprising:

a catalytic device comprising a catalytically active material,
wherein the catalytically active material is a ceramic by means of which an oxidation of exhaust compounds is catalyzable; and
wherein the catalytic device comprises a plurality of apertures through which the exhaust gases flow or may flow;
characterized in that the catalytic device comprises a bulk material comprising a plurality of bulky components.

In one embodiment, said ceramic is not a foam ceramic or does not comprise a foam ceramic.

In one embodiment, the device is characterized in that a plurality of said bulky components comprises said catalytically active material.

In one embodiment, the device is characterized in that said bulky components have one or more predetermined external shapes, which are preferably selected from the group of shapes comprising or consisting of: rings, cylinders, cones, saddles, spheres, ellipsoids, cuboids, cubes, polyeders, plates, rods, or other shapes or cuts, or combinations of these shapes.

In one embodiment, the device is characterized in that said bulk material is provided in the form of a fixed bed, which comprises bulky components.

In one embodiment, the device is characterized in that said ceramic is a technical ceramic and comprises one or more of the following: titanium oxide(s), tungsten oxide(s), molybdenum oxide(s), cordierite, corundum, in particular TiO₂, WO₃, MoO₃, ZrO₂, CeO₂, and/or Al₂O₃.

In one embodiment, the device is characterized in that the catalytically active material comprises platinum and palladium, or platinum or palladium.

In one embodiment, the device further comprises Al₂O₃.

In one embodiment, the device is characterized in that the catalytically active material comprises TiO₂ and V₂O₅.

In one embodiment, the device is characterized in that the catalytically active material comprises TiO₂ and V₂O₅ such that a disordered anatase is formed where less than 3.2% or less than 2% Ti⁴⁺ is replaced by V⁵⁺.

In one embodiment, the device is characterized in that the catalytically active material comprises gold.

In one embodiment, the device is characterized in that the catalytically active material is regenerated in case of a deactivation.

In one embodiment, the device is characterized in that it comprises a supporting device for supporting the catalytically active material.

In one embodiment, the supporting device comprises a frame and an upper and lower grid-like plate, characterized in that said catalytic device comprising said bulk material is arranged between the grid-like plates and the frame.

In one embodiment, the grid-like plate or the grid-like plates is/are in the form of expanded metal.

In one embodiment, the frame and the grid-like plates are welded with each other.

In one embodiment, the frame and the grid-like plates are in the form of expanded metal.

According to a second aspect, the invention relates to an apparatus for treating exhaust gases from a heating system, preferably a small heating system, particularly a small heating system used in private households, comprising:

a housing comprising a bottom and a cover;
at least one, preferably two devices according to the first aspect of the invention or according to any one of the embodiments according to the first aspect of the invention, which are arranged within the housing between said bottom and cover;
wherein the bottom of the apparatus has an opening through which exhaust gas is fed or may be fed from the small heating system into the apparatus.

In one embodiment, the apparatus further comprises a flap or door for maintenance or which facilitates maintenance.

In one embodiment, the apparatus is characterized in that it comprises up to 10, preferably up to 6 of the devices according to the first aspect of the invention and/or embodiments thereof.

In one embodiment, the apparatus is characterized in that said devices are detachably attached at the housing wall.

In one embodiment, the apparatus is characterized in that said devices are alternatingly attached at two opposing surfaces of the housing.

In one embodiment of the apparatus, the devices according to the invention comprise a supporting device for supporting the catalytic device, wherein the supporting device comprises a frame and an upper and a lower grid-like plate, wherein said bulk material is arranged between the grid-like plates and the frame.

In one embodiment, the apparatus is characterized in that the grid-like plates are arranged such that they enclose an angle of from 60 to 90° or from 90 to 120° with the flow direction of the exhaust gas.

In one embodiment, the apparatus is characterized in that the apparatus comprises at least one absorbing device for absorbing one or more catalyst poisons.

In one embodiment, the apparatus is characterized in that said apparatus comprises at least one device for oxidizing one or more of the following: carbon monoxide, hydrocarbons, formaldehyde, dioxins, and/or furans; and/or at least one device for converting nitrogen oxides to nitrogen; and/or at least one device for removing mercury.

In one embodiment, the apparatus is characterized in that the apparatus is located in the interior of the small heating system.

According to a third aspect, the invention relates to a heating system, preferably a small heating system, comprising:

a combustion chamber;
an exhaust gas duct for guiding exhaust gases to a discharge duct; and
the device according to the invention; or the apparatus according to the invention;
characterized in that said device or said apparatus is/are arranged in the exhaust gas duct or the discharge duct such that the gas temperature of the exhaust gas, which reaches said device or said apparatus, is from 150° C. to 800° C., or from 180° C. to 600° C., or from 180° C. to 450° C.

In one embodiment, the small heating system is characterized in that it is operated with a solid fuel, particularly with biomass such as wood or wood pellets or crops or nutmegs; or with carbon such as coal or brown coal; or with gas such as natural gas, or biogas, or town gas.

According to a fourth aspect, the invention relates to a method of manufacturing a device according to the invention, comprising the steps of:
providing a supporting device for supporting a catalytic device, which comprises a catalytically active material, wherein the catalytically active material is a technical ceramic by means of which an oxidation of the exhaust gas compounds is catalyzable; and
arranging the catalytically active material at the supporting device and providing the catalytic device such that the catalyst device comprises a plurality of apertures through which the exhaust gases flow or may flow.

According to a fifth aspect, the invention relates to a method of regenerating the device according to the invention, or a method of regenerating the apparatus according to the invention, comprising one or more of the following steps:

mechanically cleaning the catalytic device or the catalytically active material e.g. by means of an ultrasonic treatment; or by means of a solvent; or by treating with an agent for increasing the catalytic properties of the catalytically active material.

According to a sixth aspect, the invention relates to a method of treating the exhaust gases from a heating system, preferably a small heating system, comprising a device according to the invention, or comprising an apparatus according to the invention, comprising:

arranging the device or the apparatus in the exhaust gas flow.

According to a seventh aspect, the invention relates to a use of a device according to the invention, or use of the apparatus according to the invention for treating exhaust gases of a heating system.

According to an eighth aspect, the invention relates to a use of a device according to the invention, wherein the device comprises as catalytically active material platinum and/or palladium, and optionally Al₂O₃, or use of an apparatus according to the invention comprising the device according to the invention, wherein the device comprises as catalytically active material platinum and/or palladium, and optionally Al₂O₃, for oxidizing one or more of the following gases, which are contained in an exhaust gas from a heating system: carbon monoxide, hydrocarbons, formaldehyde, dioxins, furans.

According to a ninth aspect, the invention relates to the use of a device according to the invention, wherein the device is characterized in that the catalytically active material comprises TiO₂ and V₂O₅, wherein preferably the catalytically active material comprises a disordered anatase where less than 3.2% or less than 2% Ti⁴⁺ is replaced by V⁵⁺, or use of an apparatus according to the invention, which comprises the device according to the invention, wherein the device is characterized in that the catalytically active material comprises TiO₂ and V₂O₅, wherein preferably the catalytically active material comprises a disordered anatase where less than 3.2% or less than 2% Ti⁴⁺ is replaced by V⁵⁺, for converting nitrogen oxides, which are contained in the exhaust gas from a heating system, to nitrogen.

According to a tenth aspect, the invention relates to the use of a device according to the invention, wherein the catalytically active material comprises gold, or use of an apparatus according to the invention, which comprises the device according to the invention, wherein the catalytically active material comprises gold, for removing mercury, which is contained in the exhaust gas from a heating system.

### DETAILED DISCUSSION OF THE INVENTION

The object of the invention is achieved with a device for treating the exhaust gases from a heating system, preferably from a small heating system, particularly a small heating system used in private households, and/or with an apparatus comprising said device, comprising:

a catalytic device comprising a catalytically active material;
wherein the catalytically active material is a ceramic by means of which an oxidation of exhaust compounds is catalyzable; and
wherein the catalytic device comprises a plurality of apertures through which the exhaust gases flow or may flow.

In one embodiment, said ceramic is not a foam ceramic or does not comprise a foam ceramic.

The term “heating system” as used for the purpose of this disclosure encompasses any heating system or combustion system, preferably a small heating (combustion) system, a medium heating (combustion) system, or a large heating (combustion) system, in which exhaust gases may be formed.

In one embodiment, the heating system is a small heating system, which in turn is a small heating system in the meaning of the 1. BlmSchV of Dec. 3, 2009. In another embodiment, it is also possible and also preferred that the small heating system is a medium heating system (medium combustion system) in the meaning of the 1. BlmSchV of Dec. 3, 2009. In particular, a small heating system is a system having a nominal heating performance preferably of from 4 kW to 500 kW, e.g. of from 4 kW to 100 kW, or of from 4 kW to 30 kW, or of from 100 kW to 500 kW. Such small heating system may particularly be found in houses of private households, but may also be used elsewise.

In still another embodiment, the device according to the invention may also be used for treating the exhaust gases of industrial facilities, i.e. the exhaust gases of large heating systems or large combustion systems.

A heating system, preferably a small heating system, is preferably operated with solid fuels, in particular biomass such as wood or wood pellets, or crops, or nutmegs, and the like; or carbon such as coal or brown coal. It is also possible and preferred that the heating system is operated with gas such as natural gas, town gas or biogas, and the like.

The heating system such as a small heating system preferably comprises a combustion chamber and an exhaust gas duct, which receives the exhaust gas from the combustion chamber and directs it to a discharge duct, e.g. a chimney. Preferably, the device according to the invention is used for treating the exhaust gases from the small heating system or the medium heating system or even the large heating system. The device according to the invention is preferably arranged in the exhaust gas duct or the discharge duct such that the gas temperature of the exhaust gas, which reaches the device, is from 150° C. to 800° C., e.g. 150° C. to 600° C., or 180° C. to 450° C. Thereby, an optimal operating temperature of the device is achieved such that preferably a cleaning efficiency, in particular a catalytic effect of the device, proceeds better than at temperatures, which are outside of that range.

Preferably, the small heating system is realized such that the device according to the invention is arranged in a manner that a cross-section opening of the exhaust gas duct or the discharge duct is at least partially covered such that the exhaust gas flow is at least partially guided through the device. If a part of the cross-section opening remains uncovered, the flue of the exhaust gas flow is improved, which may be important for an accurate handling of the small heating system. Preferably, an adjusting device is provided at the small heating system by means of which the position of the device in the exhaust gas duct or the discharge duct may be changed in order to adjust the intensity of the exhaust gas flow, respectively the pressure loss of the exhaust gases in the exhaust gas flow by means of the device. Thereby, e.g. during the heat-up phase of the exhaust gas, the device can cover a smaller cross-section opening than in a phase of higher exhaust gas temperature, in particular from 150° C. to 800° C., or from 250° C. to 600° C., during which the device can cover a larger cross-section opening. Preferably, said adjusting device is realized such that it may be operated manually and/or automatically. An electronic control device may be provided by means of which particularly the function of the adjusting device may be controlled, e.g. may be temperature-controlled by means of optional temperature sensors, or may be controlled by means of a time switch. Thus, the operation of the small heating system may be improved.

However, it is also preferred that the small heating system is realized such, or that the device is arranged such that the cross-section opening of the exhaust gas duct or the discharge duct of the device, in particular at least during the operation of the small heating system, is completely covered such that the exhaust gas flow substantially is completely guided through the device. This has the advantage that the exhaust gas flow substantially is permanently filtered, particularly also during ignition phases of the small heating system during which the emission values are particularly high, and a filtering may be particularly efficient.

The device according to the invention preferably comprises means or characteristics by means of which the pressure drop in the exhaust gas flow across the device is smaller than 50 Pa if the device is arranged in the exhaust gas flow of a small heating system. Thus, the preferred realization of the device is achieved with the small heating system in which no additional means are necessary in order to counteract the reduction of the exhaust gas flow, which is generated by the positioning of the device within the exhaust gas flow. Basically, it is possible to let work a ventilator, e.g. an induced draft blower, within the exhaust gas duct, or in the discharge duct, in order to increase the exhaust gas flow. Thereby, however, the operation is more complex and more fault-prone. Preferably, the cross-section openings of the catalytic device are chosen such that the pressure drop in the exhaust gas flow across the catalytic device preferably is less than 50 Pa, 40 Pa, 30 Pa, 20 Pa or 10 Pa, respectively, if the device is arranged in the exhaust gas flow of a small heating system. Preferably, the device is realized such and/or in particular the apertures of the catalytic device are realized such that due to the arrangement thereof in the exhaust gas flow of a small heating system, a pressure drop across the device is generated which, however, is small enough to effect an error-free operation of the small heating system, in particular without e.g. requiring an additional blower for increasing the exhaust gas flow. Due to a lower pressure drop, the heating of a small heating system can be run more flexible, in particular can be kept in an operation range, which has less emissions and, at least indirectly, also the filtering efficiency of the device, which may be temperature-dependent, may be improved.

Preferably, the device is realized such that a cross-sectional area of the device, which is perpendicularly orientated to the exhaust gas flow, preferably is larger by a factor than that of the exhaust gas duct or the discharge duct, e.g. the chimneys, if the device or the small heating system is connected by means of this device to an exhaust gas duct or a discharge duct. This cross-sectional area is preferably defined such that it overlaps both ceramic parts of the device and also the apertures of the device. Preferably, this cross-sectional area is an area, which is framed by a frame of the optional supporting device of the device. This factor is, each preferably, a value of from 1 to 5, or from 5 to 10, or from 10 to 15, or from 15 to 20, or from 25 to 50, or is preferably larger. Preferably, this cross-sectional area is realized such, in particular by means of an adequate choice of this factor, that the pressure drop, which is effected by means of the device, within the exhaust gas flow in an exhaust gas duct or a discharge duct preferably is reduced by 50% to 75%, or preferably by 75% to 100%.

However, depending on requirements with regard to the filtering efficiency, and the mandatory pressure drop, which is related thereto, a device for increasing the exhaust gas flow may be provided, e.g. an induced draft blower, which influences the exhaust gas flow.

The small heating system according to the invention is preferably suitable or realized to be connected to a central heating which, e.g., serves for the heating of a household or multiple household in a one party house or a multiparty house.

The catalytic device of the device preferably comprises a catalytically active material, wherein the catalytically active material is a ceramic, preferably a technical ceramic (ceramics) by means of which, in particular, an oxidation of the exhaust gas compounds is catalyzable. A technical ceramic encompasses in particular ceramic materials, which have been optimized with regard to their characteristics to technical applications. This ceramic is preferably a technical ceramic and/or is preferably a not naturally occurring ceramic. However, it is also possible that the catalytic device comprises parts of naturally occurring ceramic or consists of said ceramic.

The catalytic device comprises a plurality of apertures through which the exhaust gas can flow. The term “can flow” is used in the meaning of the terms “may flow” or “capable of flowing”. The terms are interchangeably used within this disclosure.

Preferably, the apertures comprise an average cross-section of from 0.1 to 0.5 cm, preferably of from 0.50 cm to 2.0 cm, and preferably of from 2.0 cm to 4.0 cm. Said cross-section openings may be measured or estimated by means of e.g. cut pictures or other imaging techniques. By means of the adjustment of the diameter of the apertures, the pressure drop across the device is preferably adjusted, if the device is arranged in the exhaust gas flow from or of a small heating system. Within the mentioned size ranges, in particular for cross-section openings of from 0.50 cm to 2.0 cm, the pressure drop is in an optimal range such that a sufficient draft with a good filtering efficiency may be achieved.

Preferably, the catalytic device comprises a bulk material comprising a plurality of bulky components, or consists partially or completely of bulky components. The term “bulk material” encompasses a mixture of solid particles (granular material), which are loosely mixed or compactly grouted or bonded. Arrangements of solid particles “loose material” and “pile” are encompassed by the term “bulk material”. A German term for an arrangement of such solid particles is “Haufwerk”. A bulk material comprising loosely mixed bulky components may also be arranged as “fixed bed”. The use of a bulk material has the advantage that the apertures of the catalytic device need not artificially be generated, since they are already present. The clearance between the bulky components, also termed “interstice”, form said apertures. It is another advantage of the bulk material that almost any geometrical external shape of a catalytic device may be generated. This facilitates the manufacture of a device, which is adapted to dedicated small heating systems, and is easily to design for small heating systems, which are already available on the market.

Accordingly, in one aspect, the invention relates to a device for treating the exhaust gases from a heating system, preferably from a small heating system, particularly a small heating system used in private households, comprising:

a catalytic device comprising a catalytically active material;
wherein the catalytically active material is a ceramic by means of which an oxidation of exhaust compounds is catalyzable; and
wherein the catalytic device comprises a plurality of apertures through which the exhaust gases may flow;
characterized in that the catalytic device comprises a bulk material comprising a plurality of bulky components.

Advantageously, the interstices or the apertures, respectively the average cross-section opening thereof, may be influenced by means of the external geometric shape and/or by means of the volume of the bulky components. Preferably, the bulky components comprise an average cross-section diameter in the range of from 0.2 to 0.5 cm, particularly preferred of from 0.5 cm to 5.0 cm, or preferably of from 5.0 to 20 cm, or another value, in particular in case of an assumed or realistic external sphere shape. Thus, in this manner, the pressure drop may be influenced, particularly may be better planned, calculated and/or adjusted. Particularly preferred, the bulky components therefore comprise a predetermined external shape, which is not random, which, for example, may be generated by means of one or more additional process steps for the provision or manufacture of the catalytic device. However, it is also possible that the bulky components comprise a random external shape, wherein in particular the manufacture thereof is less complex.

Preferably, a plurality of the bulky components comprises this catalytically active material. Preferably, substantially all bulky components of the catalytic device comprise said catalytically active material, wherein the catalytic effect is increased. However, it is also within the present invention that only a part of the bulky components comprise the catalytically active material. For example, a proximally arranged first region of the catalytic device, i.e., in direction of the exhaust gas flow entering the device, may be provided, which comprises no or only few catalytically active material, and a distally arranged second region of the catalytic device, which thus is arranged in direction of the exhaust gas flow exiting the device. Said first region controls a temperature being preferably high enough to allow the burning of particulate matter to a high degree, in particular up from 50 to 80% or from 80 to 95%, or to allow the substantially completely burning of particulate matter, wherein the emission of the particulate matter may be particularly effectively reduced, and the temperature for the subsequent catalytic conversion in the second region may be reduced.

Preferably, the bulky components comprise one or more predetermined shapes preferably selected from a group of shapes comprising: rings, cylinders, cones, saddles, spheres, ellipsoids, cuboids, cubes, polyeders, plates, rods or other shapes or cuts or combinations of those shapes. Particularly, a rod is a shape the length thereof is larger than the height and depth thereof, preferably twice as large. In particular, a plate is a shape the length and depth thereof are larger than the height thereof, preferably twice as large. Preferably, the shape of a plurality, of a majority or of all bulky components of the catalytic device is chosen such that the pressure drop in the exhaust gas flow across the catalytic device is less than 50 Pa, if the device is arranged in the exhaust gas flow of a small heating system. Preferably, at least a first portion of the bulky components essentially comprises the same first shape and/or essentially the same first volume and/or essentially the same mass. Preferably, this first portion is 50% of the bulky components, wherein preferably a second portion of up to 50% of the bulky components essentially comprises at least a second form and/or essentially at least a second volume and/or at least essentially a second mass, wherein preferably the first and the second form, the first and the second volume and the first and the second mass are substantially different from each other. Preferably, this first portion is from 95% up to 100%, in particular essentially 100% of the bulky components.

In one embodiment, the bulk material is provided in the form of a fixed bed, which comprises said bulky components. Thereby, the bulky components may be mixed such, e.g. by pouring, that they coexist side by side or on top of each other. An optional, additional manufacturing step in which, particularly the bulky components perform oscillating or vibrating movements after the pouring, may further change the arrangement of the bulky components, particularly may improve the arrangement with respect to storage stability. In particular, a packing of bulky components may be generated, in which the bulky components are arranged at least in sections or are completely arranged in a regular manner, e.g. in a spatial lattice, the lattice points of which are arranged in sections or are completely periodically arranged. The generated packing, in particular the density and the resulting interstices thereof, in particular the one or several average cross-section opening(s) may be thereby changed respectively adjusted. For instance, bulky components in the form of rods will arrange in one or more stacks, which is caused by self-organization. A stack preferably has the property that it comprises in longitudinal direction of the elongated elements a smaller cross-section density and a larger average cross-section opening than in direction, which is perpendicular thereto, since in the plane, which is perpendicular to the longitudinal direction, a higher quantity density of apertures is developed. Furthermore, by using different main types of bulky components, e.g. by using spheres having 4 cm and spheres having 0.5 cm, a bulk material may be generated, which has other flow through properties than a bulk material, which comprises just one type or a higher plurality of types by changing the average cross-section opening of the bulk material. The clearances of the larger spheres may, for example, be occupied by the smaller spheres, which diminishes the average cross-section opening of the bulk material comprising larger spheres.

It is possible that the bulk material comprises bulky components, which are connected or bonded to each other by subjecting the bulky components after the pouring to a further processing step, in particular the bulky components are connected or bonded to each other, with or without the use of a binder.

Preferably, the catalytic device comprises a honeycomb element, the honeycombs thereof form said apertures, or comprises more honeycomb elements. The term “honeycomb element” encompasses an element, the external shape thereof has the form of a honeycomb, or which is in sections or continuously a honeycomb structure. Such honeycombs or such a honeycomb element may be provided by means of the formation of a starting material, or by means of casting a starting material, with or without the combination with a burning step or washing step, in which, for example, a lattice template, e.g. a textile, is dissolved such that only the casted starting material remains. The honeycomb element may particularly be generated by means of one bulk material, which, for example, may subsequently be sintered.

Preferably, the device, particularly the catalytically active ceramic, comprises titanium oxide(s), tungsten oxide(s), molybdenum oxide(s), cordierite, corundum, zirconium oxide(s), cerium oxide(s), silica, in particular TiO₂, WO₃, MoO₃, Al₂O₃, Ce₂O₃, or ZrO₂, or a mixture of at least two of these compounds, each preferably if possible, with a mass fraction of the ceramic of, in one embodiment at least, and in another embodiment at most, 0.01, 0.05, 0.10, 0.25, 0.5 or 0.75. It is also preferred that at least one or more of the compounds, e.g. TiO₂, WO₃, MoO₃, Al₂O₃, Ce₂O₃, or ZrO₂, preferably Al₂O₃, are not provided or are provided in the ceramic with a small mass fraction of from 0.000 to 0.1 or to 0.01 or 0.001. Furthermore, it is possible that the catalytically active ceramic is additionally doped with a metal or transition metal or a rare earth metal or more of these compounds, wherein in particular the catalytic oxidation may be further adjusted, particularly improved. Preferably, this metal is a noble metal or a transition metal, and is preferably platinum or rhodium, gold, copper, chromium, or another catalytically active transition metal or compound. Also cerium and indium can be used as doping compounds.

The ceramic preferably comprises a mass fraction of a titanium oxide, in particular TiO₂, which preferably is from 0.25 to 0.50, or preferably from 0.50 to 0.75, or preferably from 0.70 to 0.85, or from 0.85 and 0.97. It is further preferred that the ceramic comprises a mass fraction of an aluminum oxide, in particular Al₂O₃, which preferably is from 0.25 to 0.50 or preferably from 0.50 to 0.75, or preferably from 0.70 to 0.85, or from 0.85 and 0.97. Thereby, the catalytic effect of the ceramic is particularly effective.

In one embodiment, Al₂O₃ is used as a carrier for the catalytically active material of the catalytic device, e.g. as a carrier for noble metals.

Preferably, the catalytically active material catalyzes the conversion of carbon monoxide to carbon dioxide. Preferably, the catalytically active material catalyzes the cleavage of polyhalogenated dibenzodioxins and/or polyhalogenated dibenzofurans and the oxidation thereof. Preferably, the catalytically active material catalyzes the conversion of organic compounds, which may be contained in the exhaust gas, to carbon monoxide and carbon dioxide. Preferably, the catalytically active material catalyzes the conversion of polycyclic aromatic hydrocarbons (PAKs) to carbon monoxide and carbon dioxide. The catalytic device may provide the mentioned catalytic effects separately or in a combination, however, preferably, the catalytic device provides each of the mentioned catalytic effects. Preferably, the device provides the additional effect that particulate matter is burned at or in the catalytic device at least partially, and thus is filtered.

Preferably, a ceramic and/or a catalytically active ceramic of the catalytic device provides a porosity, the pores of which are preferably not identical with the apertures of the catalytic device. The pores may be micropores (smaller than 2 nm in diameter), mesopores (between 2 and 50 nm) or macropores (larger than 50 nm). Preferably, the pores are opened such that they preferably are easier to penetrate by the exhaust gases, in particular also convective, however, they may also be closed.

By means of the combination of several different materials, the function of the system may be adjusted to the typical exhaust gas conditions of a small heating system. Preferably, a ceramic is contained in a first, preferably proximally arranged layer of the catalytic device, which preferably comprises forms of sub-constituents, e.g. honeycomb sections or bulk material, having different, identical or in sections identical geometries, for example external shapes. By means of a porosity of the ceramic and thus the associated adhesive properties, non-oxidized solid of the flue gas (exhaust gas) may be adsorbed, and may be better oxidized due to the longer residence time in the hotter, proximal zone. In one or more further, in particular further distally arranged regions or layers, further ceramic material and/or catalytically active material may be provided within the catalytic device, for example the mentioned TiO₂, WO₃, MoO₃, Al₂O₃, Ce₂O₃, or ZrO₂. In particular by means of such an arrangement, the emission of particulate matter may be reduced down to 5 mg/Nm³, the emission of small-chained organic compounds down to 2 mg/Nm³, and that of carbon monoxide down to 10 mg/Nm³. In particular the prescriptive limit of the 1. BlmSchV of Dec. 3, 2009 for the emission of substances, which are harmful to the environment or which are hazardous to health, may preferably be met or is even lower, preferably when using the device according to the invention, the apparatus according to the invention, the small heating system according to the invention, and the process for treating the exhaust gases of a small heating system according to the invention.

Preferably, for achieving a sufficient catalytic effect, no additives are necessary such as ammonia, which are fed to the exhaust gas, e.g. via spraying nozzles. Furthermore, for achieving a sufficient catalytic effect and/or filtering effect, preferably no electrically driven additional equipment such as electric filters or ventilators are necessary. The device or the small heating system, which is equipped with said device, however, may comprise electrical devices such as control devices, if necessary.

Preferably, the catalytically active material, particularly the material comprising TiO₂, WO₃, MoO₃, Al₂O₃, Ce₂O₃, or ZrO₂, may be regenerated in case of deactivation such to allow the reduction of production cost, respectively the supply costs of the device.

Preferably, the ceramic is not a foam ceramic. Synonymous to foam ceramic, terms such as foam ceramics or foamy ceramics or ceramics foam are used for the purpose of the present disclosure. Initially, a foam ceramic is self-containedly regenerable by means of combustion such that no depositions remain. However, after a longer operation time the gross pores are clogged, and the reduction of particulate matter decreases. If the foamy ceramic is, for example, used in the lining of a combustion chamber of a small heating system, then it must be newly completely lined, if necessary, in order to recover the function thereof. However, it is possible that at least subsections, in particular distally arranged subsections of the catalytic device, may be made from foamy ceramic.

Preferably, the device comprises a supporting device to support the catalytically active material. Said supporting device is preferably made of a metal or comprises at least a metal, which comprises steel, iron, aluminum or other compounds, or may consist of them. Preferably, the supporting device is a casing in which the catalytically active material may be arranged or is arranged. By means of the use of a supporting device, particularly a metallic casing for the catalytic device, in particular in combination with a bulk material or a fixed bed comprising bulk material comprising bulky components, it is possible to adjust the device to the place of installation without large expenses by means of adjusting the geometry. Due to the change of geometry according to the requirements, a further optimization of the catalytic activity under optimization of the pressure drop can be conducted. The whole device or the catalytic device may preferably be removed from the combustion system after a defined operation time, and preferably may be regenerated or replaced by a new module. Thereby, the replacement is very simple and cost-effective. Preferably, the supporting device comprises a casing, which comprises an opening for filling the catalytically active material into the casing, wherein preferably a closure device for closing the opening is provided, for example a sliding lid or a hinged lid, which may comprise a locking device. Thereby, the device may be used even more flexible and possibly more cost-efficient.

In a further aspect, the invention relates to an apparatus for treating exhaust gases from a small heating system, preferably the small heating system according to the invention, comprising:

a housing comprising a bottom and a cover;
at least one device, preferably two devices according to the invention, which are arranged within the housing between said bottom and cover;
wherein the bottom of the apparatus has an opening through which exhaust gas is fed or may be fed from the heating system into the apparatus.

In one embodiment, the apparatus comprises further a flap or door, such as a flap or door for maintenance, or for facilitating maintenance.

The geometry of the apparatus according to the invention may be freely selected. Preferably, it may have the shape of a polyeder or also of a cylinder. Preferably, polyeders are cubes or cuboids.

The dimensions of the apparatus are variable. In general, they depend on the dimensions of the small heating system or structural or aesthetic conditions.

The housing of the apparatus can be made from metal and/or ceramic. In one embodiment, the housing of the apparatus is a single wall. In another preferred embodiment, the housing of the apparatus is realized as a double wall, i.e., it can consist of several layers. Said layers can be in the form of a laminate or they can be spaced from each other. If the layers of the housing are spaced from each other, then the cavity which is formed between the layer can be completely or partially filled with a heat-insulating material. A realization in several walls comprising an insulation material may, for example, be meaningful if the heat flows through the housing wall of the apparatus has to be kept low, since, as a rule, the catalytic processes running in the apparatus require heat. In one embodiment, the housing is realized such that the maximal heat emission of the apparatus is 15 kJ/(s×m²).

Within the apparatus is at least one, preferably at least two devices according to the invention, which each comprise a catalytic device comprising a catalytically active material from ceramic according to the invention. In one embodiment, the apparatus accommodates ten of said devices, preferably up to six devices.

The catalytic devices, which are used in the individual devices according to the invention, can be the same or can be different from each other. In one embodiment, within the catalytic devices of the devices according to the invention, the same active materials can be used. In a further embodiment, within the catalytic devices of the devices according to the invention, different materials are used.

The devices according to the invention are arranged within the housing of the apparatus in a manner that they can be removed from said apparatus. Then, they may be replaced by new, respectively regenerated devices according to the invention.

Preferably, the devices are attached at the housing wall within the interior of the housing such that they can be removed.

In one embodiment, said devices according to the invention are alternatingly attached at two surfaces of the housing, which oppose each other, preferably at lateral surfaces of the housing.

This may be effected thereby that the apparatus comprises suitable supporting means for the devices. Preferred supporting means are preferably hooks at which the devices may be attached, or bars on which the supporting devices may be applied.

The apparatus is also characterized in that the devices, which are within said apparatus, comprise a supporting device for supporting the catalytic device.

In one embodiment, the supporting device comprises a frame and an upper and lower grid-like plate, wherein said catalytic device comprising said bulk material is arranged between the grid-like plates and the frame.

In one embodiment, the frame is made from steel, preferably carbon steel or stainless steel such as steel 1.4828. Such types of steel are known in the art.

In one embodiment, the frame is in the form of a U-edge frame.

In another embodiment, the frame is in the form of a band steel. The term “band steel” is interchangeably used with terms such as “steel strip” or “strip metal”.

In one embodiment, the frame and the grid-like plates are welded with each other.

In one embodiment, the grid-like plate is made from steel, preferably from the same steel as the frame.

In one embodiment, the grid-like plate is in the form of a die plate. The term “die plate” is synonymously used with the term “perforated plate”.

In another and preferred embodiment, the grid-like plate is in the form of expanded metal. The term “expanded metal” is synonymously used with the term “extruded metal”. In one embodiment, the expanded metal is cold rolled or hot rolled.

In one embodiment, the open area of the expanded metal may range between 50 to 80%, or from 60 to 75%, related to the total area of the expanded metal.

In another embodiment, the expanded metal is welded onto the frame, e.g. on a frame made from band steel.

In another embodiment, two grid-like plates in the form of expanded metal are arranged such to form an upper and a lower grid-like plate, wherein the edges are welded with each other to form the frame.

In another embodiment, one grid-like plate is folded such to form an upper and a lower grid-like plate, wherein the edges are welded with each other to form the frame.

Accordingly, in one embodiment, the frame and the grid-like plates are in the form of expanded metal.

In one embodiment, the frame and/or the grid-like plates are designed such to form a cuboid.

In another embodiment, the frame and/or the grid-like plates are designed such to form a cylinder.

The devices, preferably in the form of a cassette or as cassettes, which e.g. has or have the form of a cuboid or of a cylinder, are preferably arranged within the apparatus between cover and bottom of the apparatus such that their largest areas enclose an angle of from 60 to 90° or from 90 to 120° with the flow direction of the exhaust gas (measured against clockwise direction from the surface of the cassette in direction of the flow direction of the exhaust gas).

A further embodiment is characterized in that the grid-like plates of the supporting device are arranged such that they enclose with the flow direction of the exhaust gas an angle between 60 and 90° or 90 to 120°.

If the devices are preferably alternatingly arranged at two opposing (lateral) surfaces within the housing, then the grid-like plates of the devices, which are attached to the one surface, may enclose with the flow direction of the exhaust gas an angle between 60 and 90°, and the grid-like plates of the devices, which are attached to the other surface, enclose an angle between 90 and 120°.

In one embodiment, the largest surfaces of the devices are perpendicularly flown through by the exhaust gases. The devices may be variably dimensioned. In one embodiment, they are dimensioned such that they comprise as a maximum the largest cross-sectional area of the interior of the housing of the apparatus, or cover the largest cross-sectional area of the interior of the housing of the apparatus.

In a further embodiment, the grid-like plates are dimensioned such that they cover half of the cross-sectional area of the interior of the housing, respectively.

In one embodiment, in which the devices are alternatingly arranged as described above, the grid plates are dimensioned such that opposing devices overlay each other.

Accordingly, a variety of different arrangements of the cassette or cassettes within the apparatus may be realized.

In one embodiment, the cassette or cassettes are arranged above the combustion chamber in a horizontal or inclined manner. In this embodiment, the cassette or the cassettes may be subjected to a temperature up to approx. 950° C.

In another embodiment, the cassette or cassettes are arranged below the discharge duct, wherein the cassette or the cassettes preferably have the shape of a cylinder or cylinders. In this embodiment, the cassette or the cassettes may be subjected to a temperature up to approx. 750° C.

In one embodiment, the exhaust gas from the combustion chamber may be conducted to the discharge duct via deflection plates. In this embodiment, the cassette or the cassettes may be arranged above the deflection plates in a horizontal, perpendicular or inclined manner, depending on the arrangement of the deflection plates. In this embodiment, the cassette or the cassettes may be subjected to a temperature up to approx. 600° C.

In one embodiment, if foam ceramic and/or fireclay bricks is/are used within the combustion chamber, said foam ceramic and/or fireclay brick may be replaced by one or more cassettes. In this embodiment, the cassette or the cassettes may be subjected to a temperature up to approx. 950° C.

The apparatus is realized such that it preferably comprises a detachable cover. After the detachment from the housing, the devices may be removed from the housing.

Preferably, the cover is screwed at the housing of the apparatus. By detachment of the screws, it can be removed. A sealing between cover and housing, which should prevent the escape of exhaust gas, is preferably effected by means of a cord made from ceramic.

In a further embodiment, also the bottom is detachable, preferably by means of a screw connection. Thereby, the exchange of the devices, which are within the interior of the housing, is further facilitated.

In one embodiment, the apparatus further comprises a door or a flap, such as a door or flap for facilitating maintenance.

In one embodiment, the apparatus comprises at least one absorbing device for absorbing one or more catalyst poisons. Such device may e.g. provided with basic calcium compounds.

In a further embodiment, the apparatus comprises at least one device for oxidizing one or more of the following: carbon monoxide, hydrocarbons, formaldehyde, dioxins, and/or furans; and/or at least one device for converting nitrogen oxides to nitrogen; and/or at least one device for removing mercury. Said devices may be arranged in the apparatus in any sequence.

In one embodiment, the device for adsorbing one or more catalyst poisons is arranged upstream of the at least one device for oxidizing one or more of the following: carbon monoxide, hydrocarbons, formaldehyde, dioxins, and/or furans; and/or at least one device for converting nitrogen oxides to nitrogen; and/or at least one device for removing mercury, i.e., the exhaust gas passes at first the device for adsorbing, and then any one of the other mentioned devices.

According to another aspect, the invention relates to a process for the manufacture of a device, in particular a device according to the invention, comprising the steps of:
providing a supporting device for supporting a catalytic device, which comprises a catalytically active material, wherein the catalytically active material is a technical ceramic by means of which an oxidation of the exhaust gas compounds is catalyzable; and
arranging the catalytically active material at the supporting device and providing the catalytic device such that the catalyst device comprises a plurality of apertures through which the exhaust gases may flow.

In one embodiment, the process further comprises the following steps, in any order:
providing the catalytically active material as bulk material or as fixed bed comprising or consisting of individual bulky components;
treating at least one portion or all bulky components of the bulk material of the catalytically active material such that said bulk material or said portion of bulk material comprises one or more geometrical external shapes, which may preferably be selected from a group of shapes or are shapes comprising rings, cylinders, cones, saddles, spheres, ellipsoids, cuboids, cubes, polyeders, plates, rods or other shapes or cuts or combination of these shapes.

In a further aspect, the invention also relates to a method of regenerating the catalytic devices, which are used in the device and the apparatus according to the invention.

The method according to the invention for regenerating the catalytic device of the device according to the invention or the apparatus according to the invention provides for the ability to increase the capability of the catalytically active material for catalyzing the oxidation of exhaust gas compounds due to the regeneration of the catalytic device. The method for regeneration may e.g. comprise the step of mechanically cleaning the catalytic device or the catalytically active material. The mechanical cleaning can comprise the step of an ultrasonic treatment of the catalytic device or of the catalytically active material, which thereby are preferably arranged in a solvent, which comprises organic (e.g. ethanol, DMF) or inorganic (e.g. water) components, or which consists substantially of said components. Furthermore, it may be provided that the catalytic device or the catalytically active material is treated in a further regeneration step with an agent for increasing the catalytic properties of the catalytically active material. This agent may comprise, for example, copper nitrate, platinum sulfate, or non-metal compounds.

The method according to the invention for treating the exhaust gases from a small heating system with the device according to the invention particularly provides that due to the arrangement of the device within the exhaust gas flow, the concentration of at least one compound of the exhaust gas is reduced, particularly is reduced due to a catalytically caused conversion of this compound by means of oxidation. This compound is preferably carbon monoxide, an organic compound such as a hydrocarbon or formaldehyde, PAK, polyhalogenated dibenzodioxin or dibenzofuran or preferably particulate matter.

The definitions of terms and explanation of components, means and effects are valid for all subject-matter according to the invention, i.e., the device, the small heating system comprising the device, the different mentioned methods if not mentioned otherwise or if it is not due to the context. Features of the subject-matters according to the invention and embodiments can be combined where possible or where it appears to be preferable.

Further preferred embodiments of the subject-matter according to the invention, i.e. the device, the small heating system comprising the device, the different mentioned processes, and the apparatus result from the following description of the examples in conjunction with the figures and the description thereof. Equivalent components of the examples are labeled substantially using equal reference numerals if not described otherwise or if not resulting from the context.

According to a further aspect, the invention relates to the use of a device according to the invention, or to the use of the apparatus according to the invention, for treating exhaust gases from a heating system, preferably a small heating system, or a medium heating system, or a large heating system.

In one embodiment, the invention relates to the use of a device according to the invention, and wherein the catalytic device comprises platinum and/or palladium, preferably in combination with Al₂O₃, or to the use of an apparatus according to the invention comprising the device according to the invention, wherein the device comprises platinum and/or palladium, preferably in combination with Al₂O₃, for oxidizing one or more of the following gases, which are contained in an exhaust gas from a heating system: carbon monoxide, hydrocarbons such as methane, formaldehyde, dioxines, furanes.

In another embodiment, the invention relates to the use of a device according to the invention, and wherein the catalytic device comprises TiO₂ and V₂O₅, or to the use of an apparatus according to the invention comprising the device according to the invention, and wherein the catalytic device comprises TiO₂ and V₂O₅, for converting nitrogen oxides, which are contained in the exhaust gas from a heating system, to nitrogen. In particular, a catalytic device is used which comprises a disordered anatase, wherein less than 3.2%, e.g. less than 2% Ti⁴⁺ is replaced by V⁵⁺.

In a further embodiment, the invention relates to the use of a device according to the invention, and wherein the catalytic device of the device according to the invention comprises gold, or to the use of an apparatus according to the invention, which comprises the device according to the invention, and wherein the catalytic device of said device comprises gold, for removing mercury, which is contained in the exhaust gas from a heating system.

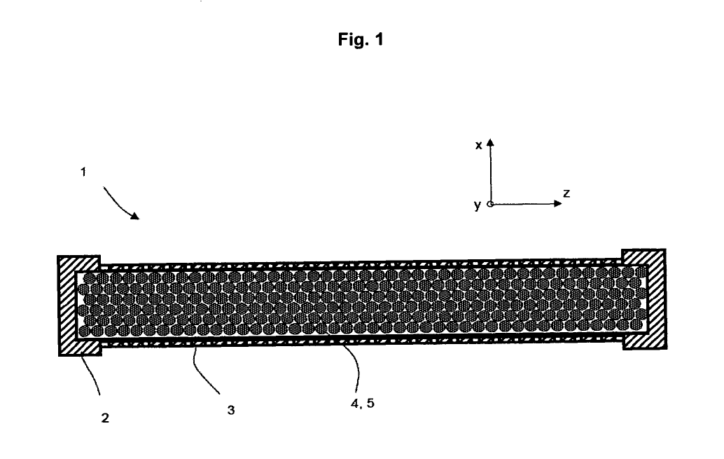

FIG. 1 shows a cross-section of a first embodiment of the device according to the invention. Said device may be inserted into the apparatus according to the invention.

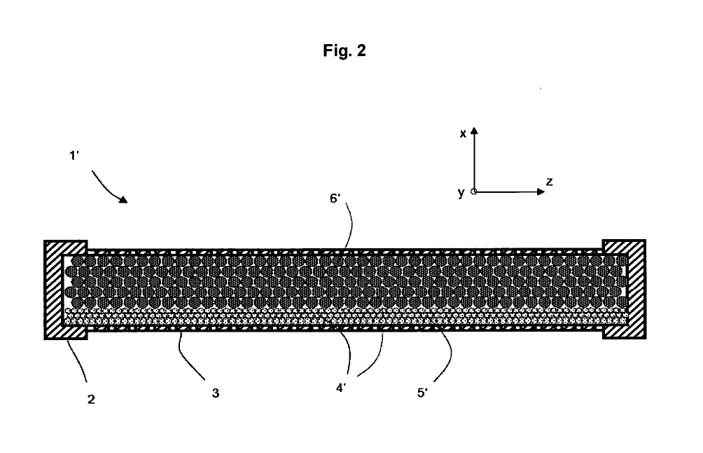

FIG. 2 shows a cross-section of a second embodiment of the device according to the invention. Said device may be inserted into the apparatus according to the invention.

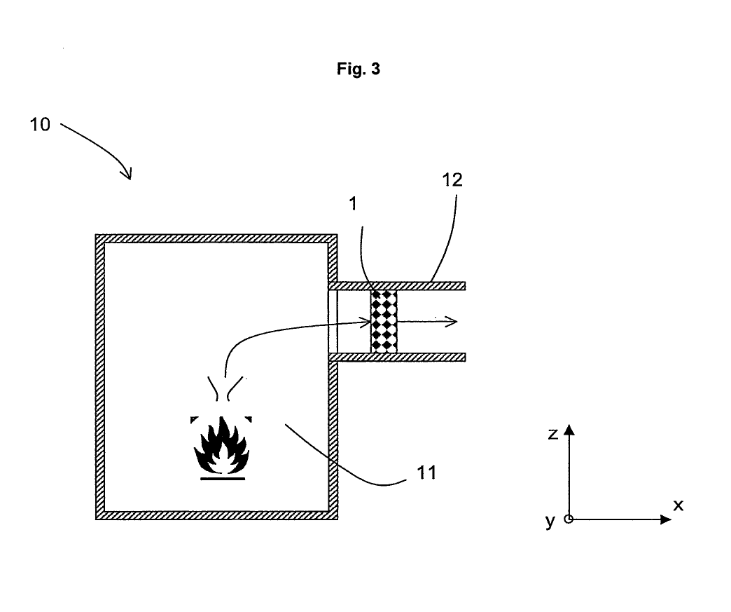

FIG. 3 shows a schematical side view of an embodiment of a small heating system, which is equipped with the device of FIG. 1.

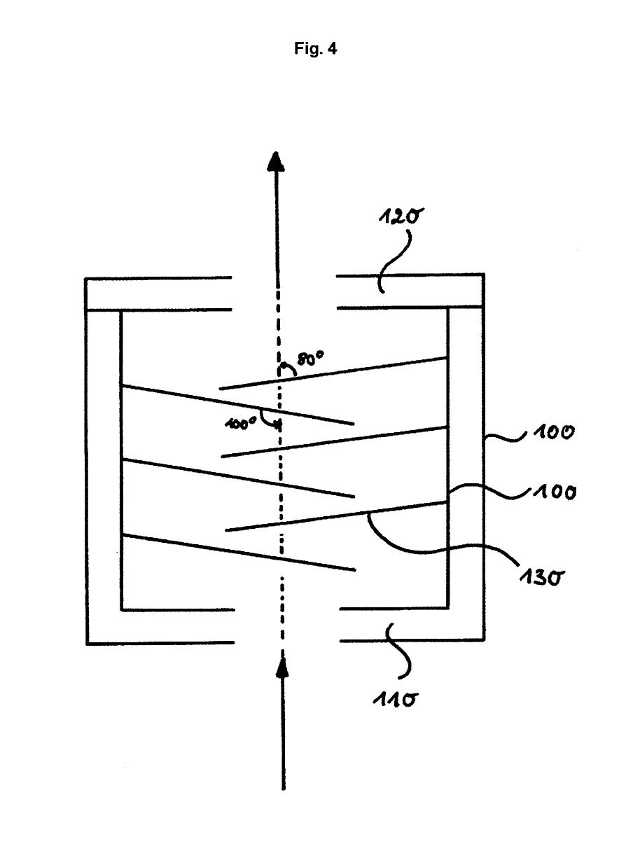

FIG. 4 shows an embodiment of the apparatus according to the invention in a cross-section.

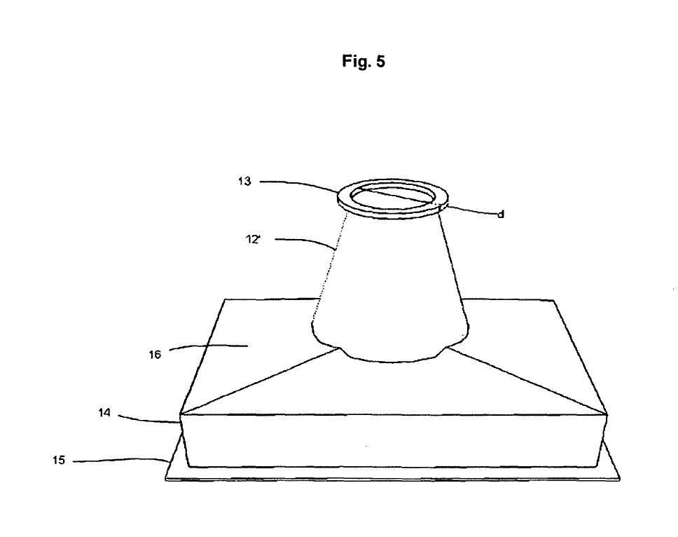

FIG. 5 shows an embodiment of an exhaust gas duct of a small heating system according to the invention, which is equipped with the apparatus or the device according to the invention.

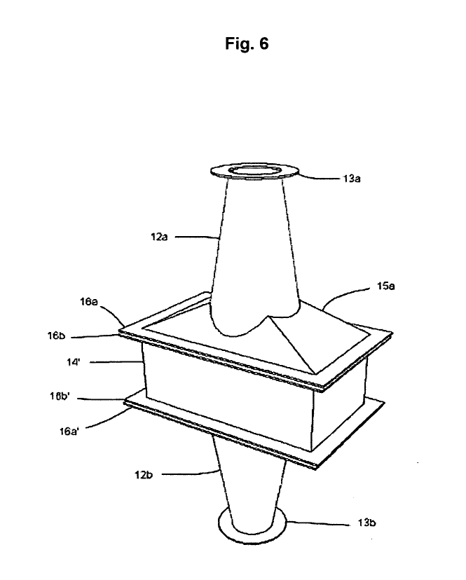

FIG. 6 shows a further embodiment of an exhaust gas duct of a small heating system according to the invention, which is equipped with the apparatus or the device according to the invention.

FIG. 1 shows a device for treating the exhaust gases from a small heating system, in particular a small heating system used in a private household. The device 1 comprises a supporting device in the form of a casing 2, 3, which comprises a metal frame 2 and an upper and lower grid-like casing plate 3, wherein the casing is formed such that it completely covers the cross-section of an exhaust gas duct of a defined type of a small heating system such that the whole exhaust gas must substantially flow through the device 1. The device 1 comprises a catalytic device 4 consisting of a fixed bed 5 of individual bulky components, which are densely packed, which, e.g., was achieved by means of vibrating the filled device 1. The packing 5 of the bulky components comprises a predetermined height, which corresponds to a multiple of the height of the spherical bulky components. The frame 2 is adapted such that it may support the plates 3 such that the packing 5 is framed in a force and frame locking manner by the casing 2, 3. The plates 3 are wide-meshedly realized such that the pressure drop of the exhaust gas flow, which is effected by the plates 3 of the casing, is lower by at least a factor 0.1, 0.1 or 0.001 than the pressure drop, which is effected by the packing 5. However, due to the relatively large cross-section of the apertures, respectively in this case the uniform average cross-section of the separate interstices between the spherical bulky components of the catalytic device 4, the pressure drop is selected such, respectively realized such that the pressure drop in the exhaust gas flow across the catalyst device 4 is lower than 50 Pa, i.e., averagely 10 Pa, if the device is arranged within the exhaust gas flow of a small heating system. Thereby, a small heating system, which is equipped with the device 1, particularly may be run error-free without an additional blower, which increases the exhaust gas flow (the draft) in order to compensate a reduction of the pressure. Since an additional blower causes costs, a cost-effective and effective reduction of emissions may be achieved in this manner.

The catalytically active material of the catalytic device 4 is a microporous, technical ceramic (ceramics) by means of which an oxidation of exhaust gas compounds is catalyzable. The ceramic comprises as catalytically active material TiO₂ (mass fraction 0.75), WO₃ (mass fraction 0.05) and V₂O₅ (mass fraction 0.05) as well as several other compounds. Particularly due to this arrangement, the emission of particulate matter may be reduced down to 9 mg/Nm³, the emission of small-chained organic compounds may be reduced down to 4 mg/Nm³, and those of carbon monoxide may be reduced down to 14 mg/Nm³. Particularly in inappropriate use, the catalyst device 4 may be recovered by means of regeneration.

FIG. 2 shows a second embodiment of the device 1′ according to the invention in a cross-section. This corresponds to the embodiment of FIG. 1 except for the arrangement of the catalytic device. The catalytic device 4′ of the device 1′ comprises a first layer 5′ consisting of a microporous ceramic, which substantially contains hardly catalytically active ceramic, which, e.g. substantially comprises no TiO₂, WO₃, MoO₃ or V₂O₅, or at least only in lower mass fraction of, for example, less than 0.005, wherein the bulky components 5′ of the first layer are densely packed ellipsoids of this ceramic. The first layer 5′ is to be proximally arranged, i.e., facing the small heating system. Furthermore, the catalytic device 4′ of the device 1′ comprises a second layer 6, which comprises a microporous, catalytically active ceramic. Particularly due to inappropriate use, also the catalytic device 4′ may be recovered by regeneration.

The catalytically active material of the catalytic device 4′ is a microporous, technical ceramic (ceramics) by means of which an oxidation of compounds in the exhaust gas is catalyzable. The ceramic comprises as catalytically active material TiO₂ (mass fraction 0.75), WO₃ (mass fraction 0.05), V₂O₅ (mass fraction 0.03) and MoO₃ (0.02), as well as some further compounds. In particular, due to this arrangement, the emission of particulate matter can be reduced down to 5 mg/Nm³, the emission of small-chained organic compounds down to 2 mg/Nm³, and the emission of carbon monoxide down to 10 mg/Nm³. By means of the combination of several different materials in this first layer 5′ and this second layer 6, the function of the system may be adapted to the typical exhaust gas conditions of a small heating system. Due to the porosity of the ceramic, and due to the adhesive properties associated therewith, non-oxidized solid compounds are adsorbed from the flue gas (exhaust gas), and are better oxidized due to the longer residence in the hotter, proximal zone of the first layer 5′. In one or more further regions, in particular regions or layers of the layer 6, which are arranged more distally, the catalytically active material is provided in the catalytic device, for example the mentioned TiO₂, WO₃, MoO₃ and V₂O₅. This material catalyzes the conversion of carbon monoxide to carbon dioxide, the cleavage of polyhalogenated dibenzodioxins and/or polyhalogenated dibenzofurans, and the oxidation thereof, the conversion of organic compounds, which may be contained in the exhaust gas, to carbon monoxide and carbon dioxide, the conversion of polycyclic aromatic hydrocarbons (PAKs) to carbon monoxide and carbon dioxide, and the conversion of polycyclic aromatic hydrocarbons (PAKs) to carbon monoxide and carbon dioxide. Since additionally the effect is given that particulate matter is significantly reduced by means of the catalytic device, an effective and cost-effective device comprising a catalytic device is generated, which may be used for treating exhaust gases, in particular for the reduction of the emission of a small heating system.

FIG. 3 shows a small heating system 10 in a schematical view. The small heating system 10 is a heating system for a single room according to BlmSchV from Dec. 3, 2009 with a nominal heat output of 8 kW for a private household, which can be used for the heating of a room. The small heating system comprises a combustion chamber 11 and an exhaust gas duct 12, which receives the exhaust gas from the combustion chamber, and conducts it to a discharge duct, for example a chimney, and in which the device 1 or 11 is arranged such that it covers the cross-section of the duct 12 substantially completely such that the exhaust gases from the combustion of wood have to flow substantially completely through the device 1. The device is arranged such within the exhaust gas duct or the discharge duct, in particular arranged in a distance from the combustion chamber 11 such that the gas temperature of the exhaust gas, which reaches the device, is between 150° C. and 800° C. Therefore, an optimal temperature of the exhaust gases at the proximal side (in FIG. 3 left) of the device 1 is achieved such that an effective catalysis and filtering is effected.

FIG. 4 shows an embodiment of the apparatus according to the invention. The apparatus is realized in the form of a cube. It comprises a housing 100, which is realized with two walls. It comprises a bottom 110 comprising an opening for entering exhaust gas from a small heating system, and a detachable cover 120 comprising an opening for exiting treated exhaust gas, which, for example, is guided to a chimney. Within the apparatus are devices 130 comprising catalytic devices, for example devices according to FIG. 1 or 2. Said devices, are alternatingly arranged at opposing, lateral surfaces of the housing. The devices should have the form of a cassette. The devices on the right side of the apparatus enclose with the flow direction of the exhaust gas an angle of approximately 80°, the opposing devices on the left side an angle of approximately 100°.

FIG. 5 shows an embodiment of an exhaust gas duct 12′ of a small heating system comprising the apparatus according to the invention comprising the housing 14 comprising cover 16 and bottom 15. The apparatus, in turn, comprises the device 1, 1′ according to the invention. Shown is a part of an exhaust gas duct, which has to be distally arranged, for a small heating system, which is connected with its distal flange 13 to a discharge duct, for example a chimney. Integrated into the discharge duct 12′, for example by integrated forming, welding, soldering, or by another form and force locking connection, is a cover 16 of the apparatus according to the invention. Preferably, in said arrangement, substantially the total exhaust gas flow flows through the apparatus. At the lateral section of the housing 14 of the apparatus, within the interior of the housing devices 1, 1′ are mounted. The housing 14 is connectable via a bottom 15, which may be realized as flange, to the proximal part of the exhaust gas duct 12′, which in turn is connected to the combustion chamber of the small heating system. The bottom/flange 15 can be connected to the opposing flange 15′ (not shown) of the proximal portion. The proximal portion might also equally or similarly be realized as compared to the shown distal portion. Said portion 15 might also be differently formed. The cross-section of the devices is approximately 24 times as large as the cross-section of the exhaust gas duct 14, which, for example, is defined by the inner diameter d=250 mm of the flange section 13, preferably, however, by means of the smallest determined cross-section of the exhaust gas duct or the discharge duct. Thereby, the pressure drop, which is effected by means of the device, is reduced to 90%, wherein a regular operation of the small heating system according to 1. BlmSchV is achieved.

The housing 14 is preferably realized such that it contains the device according to the invention in a form and force locking manner. The housing 14 comprises external wall sections parallel to the flow direction, which simply is assumed to be linear. The wall sections define a cuboid-like pipe section, which receives a substantially cuboid device. However, the wall sections may also define a differently formed pipe section, which receives a correspondingly differently shaped device. These wall sections might define, for example, a substantially hollow-cylindrical, hollow-truncated cone, or elsewise shaped pipe section, in which then a substantially hollow-cylindrical, hollow-truncated cone, or elsewise shaped pipe section is arranged.

A tapered, hollow-conic section connects the housing section to the distal section 12′ of the discharge duct, which is connected to the chimney. This section might also be shaped differently. Preferably, the device is realized such that a cross-sectional area of the device, which is perpendicularly orientated with respect to the exhaust gas flow, is preferably larger by a factor than that of the exhaust gas duct or the discharge duct, for example the chimney, if the device or the apparatus or the small heating system is connected to an exhaust gas duct or discharge duct. The cross-sectional area of the device substantially corresponds to the cross-sectional area of the housing 14, perpendicular to the exhaust gas flow direction. The frame of the device, for example the frame 2, however, limits said cross-sectional area. The cross-sectional area is approximately 24 times as large as the cross-sectional area of the exhaust gas duct 14, which, for example, is defined by an internal diameter d=250 mm of the flange section 13, however preferably by the smallest provided cross-sectional area of the exhaust gas duct or the discharge duct. Thereby, the pressure drop, which is effected by the device, is reduced by 90%, wherein a low emission of pollutants and a proper operation of the small heating system according to the 1. BlmSchV is achieved.

The housing 14 is connectable via a flange 15 with the proximal portion of the exhaust gas duct 12′, which is connected to the combustion chamber of the small heating system. The flange 15 can also be connected to a counterflange 15′ (not shown) of the proximal portion. The proximal portion might be realized equally or similar as compared to the shown distal portion.

FIG. 6 shows another embodiment of an exhaust gas duct of a small heating system, comprising the apparatus according to the invention, which comprises a housing 14′, a cover 16a and a bottom 16b′. Said apparatus, in turn, comprises the device according to the invention. The exhaust gas duct comprises the distal section 12a and the proximal section 12b. The housing section 14′ is usable via the two flange connections 16a, 16b and 16a′ and 16b′ in a gas-tight manner with the exhaust gas duct. Also here, the proximal and the distal portion are preferably realized similarly or equally. By means of said arrangement, the devices, in particular by said means (housing section 14, 14′) for the arrangement of the devices within the exhaust gas duct and/or said means for changing the devices (flange connections 16a, 16b and 16a′ and 16b′), may particularly easily be removed, and in particular the change of the devices, for replacement or for regeneration of the devices or the catalytic devices, can be comfortably effected.

1-20. (canceled)

21. A device for treating exhaust gases from a heating system, the device comprising:
a catalytic device comprising a catalytically active material,
wherein the catalytically active material is a ceramic by means of which an oxidation of exhaust compounds is catalyzable; and
wherein the catalytic device comprises a plurality of apertures through which the exhaust gases may flow and a bulk material comprising a plurality of bulky components.

22. A device according to claim 21, wherein
a plurality of the bulky components comprises the catalytically active material; or
a plurality of the bulky components comprises the catalytically active material and the bulky components have one or more predetermined external shapes.

23. A device according to claim 22 wherein the one or more predetermined external shapes are selected from the group consisting of rings, cylinders, cones, saddles, spheres, ellipsoids, cuboids, cubes, polyhedrons, plates, rods, and combinations thereof.

24. The device according to claim 21 wherein said bulk material is provided in the form of a fixed bed, which comprises bulky components.

25. A device according to claim 21, wherein said ceramic is a technical ceramic comprising one or more of titanium oxide, tungsten oxide, molybdenum oxide, cordierite, and corundum.

26. A device according to claim 25 wherein the technical ceramic is selected from the group consisting of TiO₂, WO₃, MoO₃, ZrO₂, CeO₂, Al₂O₃, and combinations thereof.

27. A device according to claim 21, wherein the catalytically active material comprises:
platinum and palladium;
platinum or palladium;
TiO₂ and V₂O₅;
TiO₂ and V₂O₅ wherein the catalytically active material comprises a disordered anatase where less than 3.2% or less than 2% Ti⁴⁺ is replaced by V⁵⁺; or
gold.

28. A device according to claim 21 further comprising a supporting device for supporting the catalytic device.

29. A device according to claim 28, wherein the supporting device comprises a frame and an upper and lower grid-like plate, and the catalytic device is arranged between the grid-like plates and the frame.

30. A device according to claim 29 wherein at least one of the grid-like plates is in the form of expanded metal.

31. A device according to claim 29 wherein the frame and the grid-like plates are welded with each other.

32. A device according to claim 31 wherein the frame and the grid-like plates are in the form of expanded metal.

33. A device according to claim 21 further comprising a housing, the housing comprising a bottom, a cover and walls, wherein the device is arranged within the housing between the bottom and the cover, and wherein the bottom of the housing has an opening through which exhaust gas is fed or may be fed from a small-sized firing system into the device.

34. A device according to claim 33 wherein the housing further comprises a flap for maintenance.

35. A device according to claim 33 wherein up to ten of the devices are arranged within the housing.

36. A device according to claim 33 wherein the device is
detachably attached to at least one wall of the housing;
alternatingly attached at two opposing surfaces of the housing; or
detachably attached to at least one wall of the wall and alternatingly attached at two opposing surfaces of the housing.

37. A device according to claim 33 further comprising a supporting device for supporting the catalytic device, wherein the supporting device comprises a frame and an upper and a lower grid-like plate, wherein the catalytic device is arranged between the grid-like plates and the frame.

38. A device according to claim 37, wherein the grid-like plates are arranged such that they enclose an angle of from 60 to 90° or from 90 to 120° with the flow direction of the exhaust gas.

39. A device according to claim 33 wherein the apparatus further comprises at least one of:
at least one absorbing device for absorbing one or more catalyst poisons;
at least one device for oxidizing one or more of carbon monoxide, hydrocarbons, formaldehyde, dioxins, and/or furans;
at least one device for converting nitrogen oxides to nitrogen; and
at least one device for removing mercury.

40. A device according claim 33 further comprising a small heating system wherein the housing is within the interior of the small heating system.

41. A device according to claim 21 further comprising a small heating system, wherein the small heating system comprises
a combustion chamber;
an exhaust gas duct for guiding exhaust gases to a discharge duct;
wherein the device is arranged in the exhaust gas duct or the discharge duct such that the gas temperature of the exhaust gas, which reaches said device is from 150° C. to 800° C.

42. A device according to claim 33 further comprising a small heating system, wherein the small heating system comprises a combustion chamber;
an exhaust gas duct for guiding exhaust gases to a discharge duct;
wherein the housing containing the device is arranged in the exhaust gas duct or the discharge duct such that the gas temperature of the exhaust gas, which reaches said device is from 150° C. to 800° C.

43. A device according to claim 42 wherein the small heating system is operated with
biomass fuel selected from the group consisting of wood, wood pellets, crops, nutmegs, and combinations thereof;
carbonaceous fuel selected from the group consisting of coal, brown coal, and combinations thereof; or
gaseous fuel selected from the group consisting of natural gas, biogas, town gas, and combinations thereof.

44. A device according to claim 42 wherein the small heating system is operated with
biomass fuel selected from the group consisting of wood, wood pellets, crops, nutmegs, and combinations thereof;
carbonaceous fuel selected from the group consisting of coal, brown coal, and combinations thereof; or
gaseous fuel selected from the group consisting of natural gas, biogas, town gas, and combinations thereof.

45. A method of manufacturing a device according to claim 21 comprising:
providing a supporting device for supporting the catalytic device; and
arranging the catalytically active material at the supporting device and providing the catalytic device such that the catalyst device comprises a plurality of apertures through which the exhaust gases may flow,
wherein the catalytically active material is a technical ceramic by means of which an oxidation of the exhaust gas compounds is catalyzable

46. A method of regenerating a device according to claim 21 comprising mechanically cleaning the catalytic device or the catalytically active material.

47. A method according to claim 46 wherein the mechanical cleaning is selected from the group consisting of ultrasonic treatment, solvent treatment, treatment with an agent for increasing the catalytic properties of the catalytically active material, and combinations thereof.

48. An apparatus for treating exhaust gases from a heating system comprising
(a) a housing comprising a bottom, a cover and walls, and
(b) at least one catalytic device comprising a catalytically active material, wherein the catalytically active material is a ceramic by means of which an oxidation of exhaust compounds is catalyzable; and wherein the catalytic device comprises a plurality of apertures through which the exhaust gases may flow and a bulk material comprising a plurality of bulky components;
wherein the catalytic device is arranged within the housing between the bottom and the cover, and wherein the bottom of the housing has an opening through which exhaust gas is fed or may be fed from a small-sized firing system into the device.

49. A device for treating exhaust gases from a heating system, the device comprising:
a catalytic device comprising a catalytically active material,
wherein the catalytically active material is a technical ceramic by means of which an oxidation of exhaust compounds is catalyzable; and
wherein the catalytic device comprises a plurality of apertures through which the exhaust gases may flow and a fixed bed of bulk material comprising a plurality of bulky components.
